(19) United States
(12) Patent Application Publication
(10) Pub. No.: US 2007/0182054 A1
(43) Pub. Date: Aug. 9, 2007

(54) Method for manufacturing product markers

(76) Inventor: Wayne M. Kachmar, North Bennington, VT (US)

Correspondence Address: MERCHANT & GOULD PC, P.O. BOX 2903, MINNEAPOLIS, MN, 55402-0903, US

(21) Appl. No.: 11/652,375

(22) Filed: Jan. 11, 2007

Related U.S. Application Data
(60) Provisional application No. 60/758,459, filed on Jan. 12, 2006.

(51) Int. Cl. B29C 47/00

(52) U.S. Cl. 264/148; 264/159

(57) ABSTRACT

A method of manufacturing a consumable product marker for use in the food or pharmaceutical industry is disclosed. The product marker is configured to be consumed along with products into which the product marker has been incorporated. The product marker comprises at least one identification opening extending through the product marker. The method of manufacturing the product marker includes extruding a polymeric elongate precursor marker structure defining a cross-width, cooling the extruded precursor marker structure to set an extruded shape of the precursor marker structure, and cutting the precursor marker structure to form a plurality of product markers. A draw-down process may be used during the extrusion process to reduce the cross-width of the precursor marker structure.

### CROSS REFERENCE TO RELATED APPLICATION

This application claims the benefit of U.S. Provisional Application Ser. No. 60/758,459, filed Jan. 12, 2006, which application is hereby incorporated by reference in its entirety.

### TECHNICAL FIELD

The present invention relates generally methods for manufacturing products using extrusion techniques. More particularly, the present invention relates to methods for manufacturing product identifier markers using extrusion techniques.

### BACKGROUND

Product markers are small elements that can be incorporated into products such as pharmaceuticals or food products to allow the origin of the products to be readily confirmed. U.S. Pat. No. 6,951,687, which is hereby incorporated by reference in its entirety, discloses example product marker configurations.

Product markers used in the food and pharmaceutical industries are typically intended to be consumed along with the products into which they have been incorporated. It is preferred for the markers not to affect the flavor or texture of the products into which they have been incorporated. This being the case, product markers are generally small in size. Additionally, the markers are typically manufactured to relatively close tolerances and often have fairly intricate shapes or patterns incorporated therein. The above factors make the effective mass production of product markers a difficult endeavor.

### SUMMARY

One aspect of the present disclosure relates to methods and systems for efficiently manufacturing product markers.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 shows an example identifier marker;

FIG. 1A shows a side view of the marker of FIG. 1;

FIG. 2 is a flow chart showing an example manufacturing sequence having inventive aspects in accordance with the principles of the present disclosure;

FIG. 3 is a high-level schematic diagram of a system in accordance with the principles of the present disclosure for manufacturing product identifiers;

FIG. 4 is a cross sectional view of an extrusion device having inventive aspects in accordance with the principles of the present disclosure;

FIG. 5 is a cross sectional view taken along section line 3-3 of FIG. 4; and

FIG. 6 is a schematic diagram of a conventional draw tower.

### DETAILED DESCRIPTION

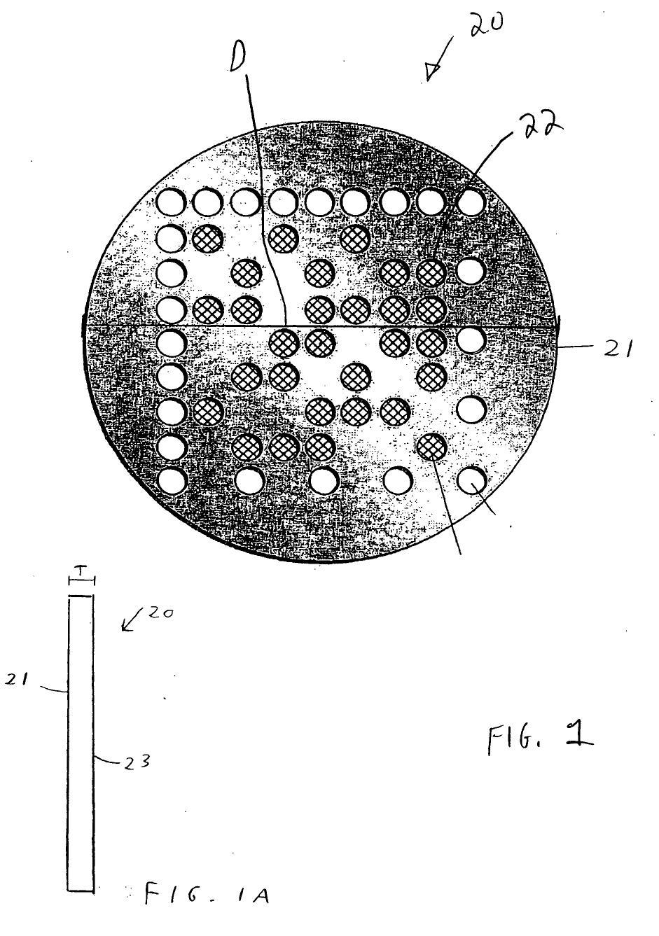

The present disclosure relates generally to systems for manufacturing relatively small identifier markers. Example identifier markers are disclosed in U.S. Pat. No. 6,951,687, that was previously incorporated by reference. FIG. 1 shows one example type of identifier marker 20 that can be manufactured in accordance with the methods disclosed herein. The marker 20 includes a plurality of openings 22 that extend through the marker. It will be appreciated that the size, position and number of the openings can be used as a means for identifying the marker.

According to certain preferred embodiments of the markers 20, the maximum distance D across the marker face 21 (i.e., the maximum diameter) is between 0.5 micrometers and 5 millimeters. More preferably, the maximum distance is between 1 micron and 1 millimeter, and even more preferably between 10 micrometers and 250 micrometers. Most preferably, the maximum distance across the face 21 of the markers 20 is between 30 micrometers and 100 micrometers.

According to still other certain embodiments, the maximum distance across the face 21 of the markers 20 is less than 500 micrometers. More preferably, the maximum distance is less than 300 micrometers, and even more preferably less than 100 micrometers. Most preferably, the maximum distance across the face 21 of the markers 20 is less than 40 micrometers.

The maximum thickness T of the markers 20 (i.e. the maximum distance between a front face 21 and a back face 23) may be any value suitable for the intended use of the markers 20. Accordingly, one skilled in the art may determine such values empirically and can vary such values as appropriate based on the intended application thereof.

According to certain preferred embodiments, the maximum thickness T of the markers 20 is between 0.5 micrometers and 100 micrometers. More preferably, the maximum thickness is between 0.5 micrometers and 50 micrometers, even more preferably between 1 micrometers and 20 micrometers and still even more preferably between 1 micron and 10 micrometers. Most preferably, the maximum thickness of the markers is between 3 micrometers and 5 micrometers.

In certain embodiments, an aspect ratio of the mean distance D across the face 21 to the mean thickness T of between 1:1 and 200:1 is possible.

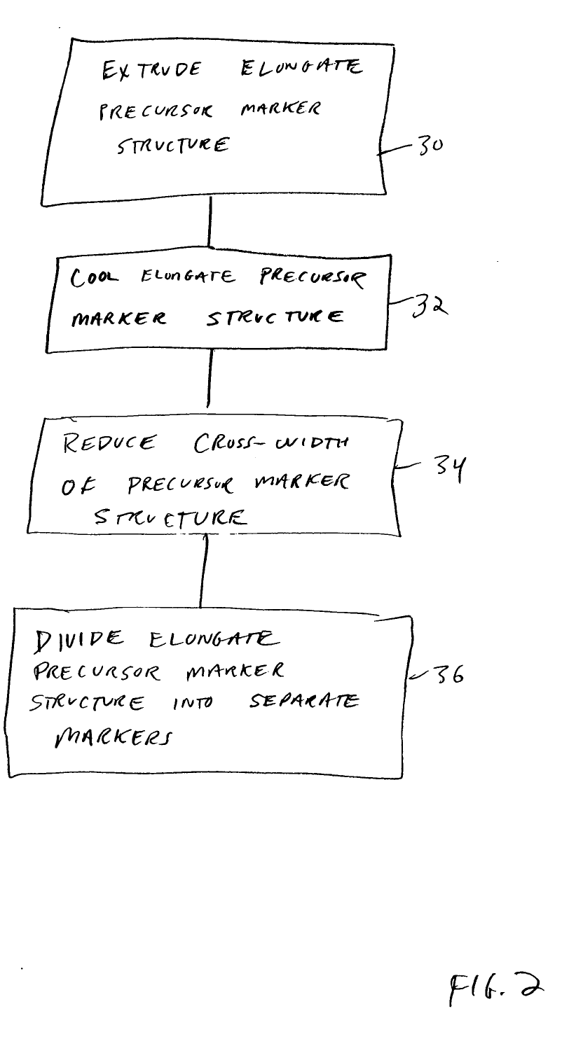

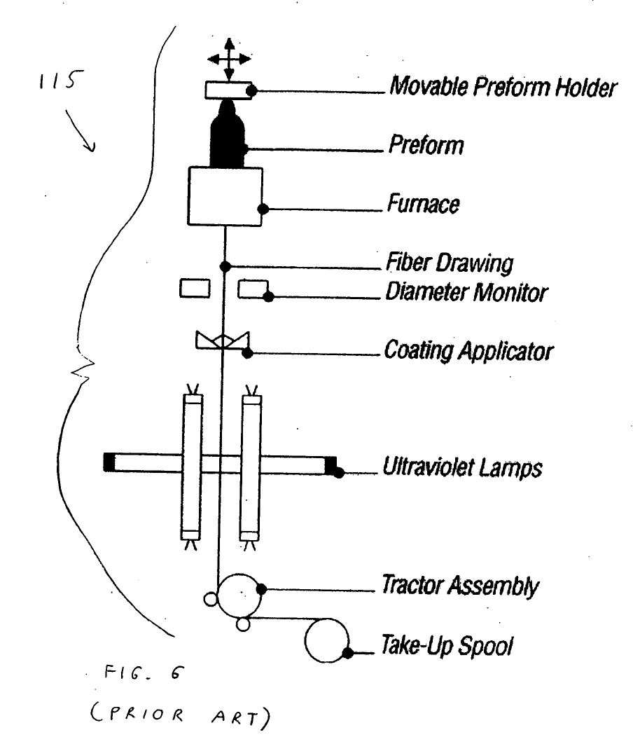

FIG. 2 is a flow chart showing an example processing method in accordance with the principles of the present disclosure for manufacturing identifier markers. At operation 30 of the process, an elongate precursor marker structure is extruded. The elongate precursor marker structure may include a desired pattern of openings formed therein and may also include a desired pattern or contour provided about the perimeter of the precursor marker structure. The extrusion operation may include a draw-down process to reduce the cross width (e.g., the outer diameter) of the precursor marker structure. Typical draw down ratios as part of the extrusion process may be from about 5:1 to about 25:1. After operation 30, the precursor marker structure is cooled at operation 32 to set the extruded shape of the precursor marker structure. Thereafter, the cross-width of the precursor marker structure can be further reduced at operation 34. In one embodiment, operation 34 can include a draw tower (see FIG. 6) at which the precursor marker structure is re-heated and further elongated to reduce the cross-width to a final desired cross-width dimension. Once the final cross width has been set, the precursor marker structure is divided at operation 36 (e.g., sliced, cut, sheared or otherwise separated into multiple pieces) to provide a plurality of separate identifier markers each having the same outer cross sectional shape and the same pattern of openings formed therein. In preferred embodiments, the precursor marker structure is sliced along planes generally perpendicular to a longitudinal access of the precursor marker structure.

Any suitable polymer, natural or synthetic, which has the desired characteristics for the intended applications of the identifier marker 20 can be used to manufacture the markers 20 through extrusion. Suitable polymers for use in the production of the markers 20 include biodegradable polymers and non-biodegradable polymers, water-soluble polymers and water-insoluble polymers, organic solvent-soluble polymers and organic solvent-insoluble polymers, natural polymers and synthetic polymers, and edible polymers and non-edible polymers.

Certain specific examples of suitable polymers for use in the manufacture of the markers 20 include, but are not limited to, polylactide, hydroxypropyl cellulose, hydroxyethylcellulose, carboxymethyl cellulose, ethyl cellulose, starch, chitin, silk, zein, acrylonitrile-butadiene-styrene, polymethylmethacrylate, polyhydroxyethylmethacrylate, cellulose acetate, cellulose acetate butyratc, cellulose acetate propionate, polycarbonate, polystyrene, polyvinyl acetate, polyvinyl alcohol, styrene-acylonitrile, unplasticised (rigid) polyvinyl chloride, plasticised (flexible) polyvinyl chloride, high impact polystyrene, polyoxymethylene, polyformaldehyde (polyacetal), ethylene vinyl acetate copolymer, polyamide (nylon), polyethylene terephthalate (polyester), polybutylene terephthalate, low density polyethylene, linear low density polyethylene, high density polyethylene, polypropylene, poly 4-methyl pentene, polytetrafluoroethylene (ptfe), polyvinylidene fluoride (pvdf); and co-polymers or mixtures of any two or more thereof. Preferably the most suitable materials include pvdf or ptfe.

Preferred mixtures of polymers include mixtures of lower and higher molecular weight polymers and/or mixtures of D- and L-isomers of the same or different polymers, which may, for example, affect the melting point or optical properties of the polymer.

The polymers that are useful with extrusion processes include thermoplastics, elastomers before crosslinking, and thermosets before crosslinking. Thermoplastics include polyesters, polyamides, polyethers, polyolefins, halogenated polyolefins, fluorinated polyolefins, thermoplastic polyimides, poly(imide-ethers) and polycarbonates, and the like. Polymers which are extruded may also contain the usual additives such as fillers, reinforcing agents, antioxidants, colorants, pigments, etc. Exemplary of these are carbon black, glass fiber, clay, mica, graphite fiber, titanium dioxide, carbon fibers and natural fibers.

At operation 30 of the process, an elongate precursor marker structure is extruded to a cross-width of between 1 cm and 5 cm. As discussed previously, this extrusion operation 30 may include a draw-down process to further reduce the cross width (e.g., the outer diameter) of the precursor marker structure at a ratio of about 5:1 to about 25:1. Operation 30 is preferably a vertical extrusion process.

After operation 30, the precursor marker structure is cooled at operation 32 to set the extruded shape of the precursor marker structure. Thereafter operation 30 and 32, the cross-width of the precursor marker structure can be further reduced at operation 34. Operation 34 involves utilizing a draw tower to further reduce the cross-width of the extruded precursor marker structure.

Referring to a schematic diagram in FIG. 6, in a draw tower 115, the lower end of the preformed extrude is slowly fed into a furnace where it turns into a molten state. The formed molten gob falls down under the force of gravity while shrinking in diameter into the proper desired width. The diameter is normally controlled continuously during the drawing process. The draw-down ratio may be typically from 100:1 to 1000:1. Other ratios are also possible depending on the end width required. Despite tremendous reduction in cross-sectional area, the relative geometrical profile of the marker remains unchanged.

In certain applications, in a typical draw tower, the drawn polymer may be threaded through a series of coating applicators immediately after drawing. Liquid prepolymer coatings may be cured by thermal or ultraviolet apparatuses. A device such as a laser device immediately below the furnace may measure the diameter of the drawn polymer and any deviation from the programmed value is corrected by minute adjustments of the drawing speed.

Example draw towers are available from Corning Incorporated, Draka Fibre Technologies, and Delachaux. Since the configuration and the operation of such draw towers are known in the art, further details thereof will not be provided herein, it being understood that those skilled in the art understand the nature of such an apparatus.

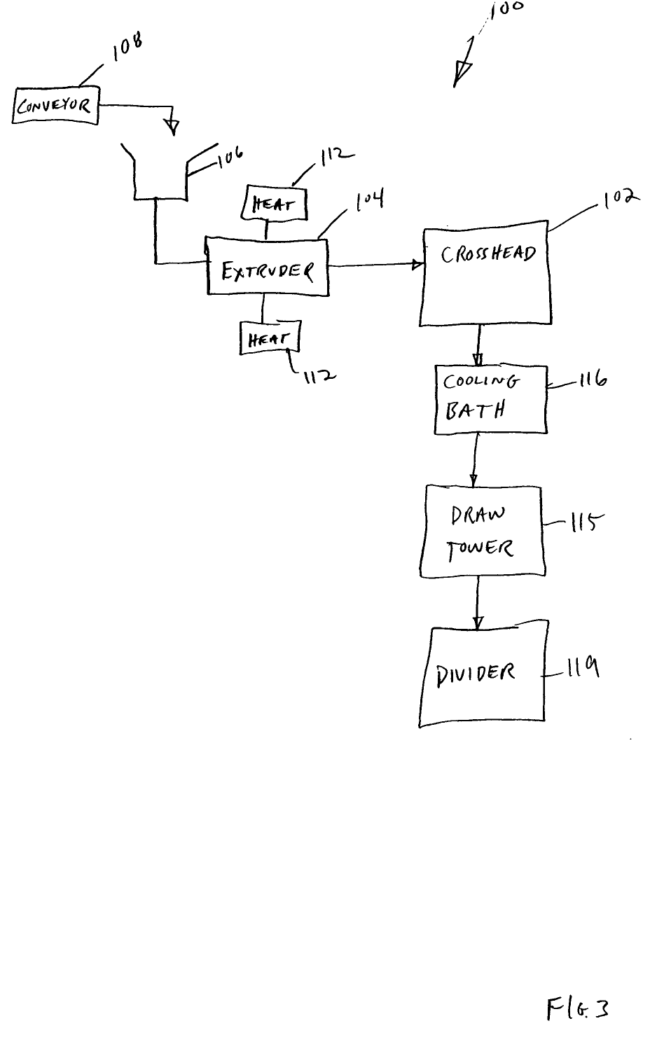

FIG. 3 is a schematic diagram showing an example system in accordance with the principles of the present disclosure for manufacturing identifier markers. The system 100 includes a crosshead 102 that receives thermoplastic material from an extruder 104 (e.g., an auger style extruder or other type of extruder). A conveyor 108 conveys material (e.g., thermoplastic material in pellet form, fillers or other materials) to a hopper 106 that directs the material into the extruder 104. The extruder 104 is heated by a heating system 112 that may include one or more heating elements for heating zones of the extruder as well as the cross head to desired processing temperatures. The extruder 104 functions to heat and masticate the thermoplastic material, and also provides pressure for forcing the thermoplastic material through the crosshead 102. The cross head 102 may include tips and dies configured to impart a desired cross sectional shape to the material being conveyed through the cross head 102.

Referring still to FIG. 3, a cooling structure 116 (e.g., a liquid bath such as a water bath) is located downstream from the crosshead 102. The cooling tank functions to cool the extruded product so as to set the cross sectional shape of the product. After cooling, a draw tower 115 can be used to further reduce the cross-width of the product extruded from the crosshead 102 as discussed previously. Once the product is drawn to the desired size, a divider 119 is used to divide the product into a plurality of separate, identical identifier markers.

The drawn product may be cut into a plurality of markers by any of the methods and techniques known to those skilled in the art. Preferably, the primary polymeric fiber is cut with a microtome or guillotine-type device. In other embodiments, other cutting methods include mechanical cutting techniques, laser cutting, etching, or other techniques.

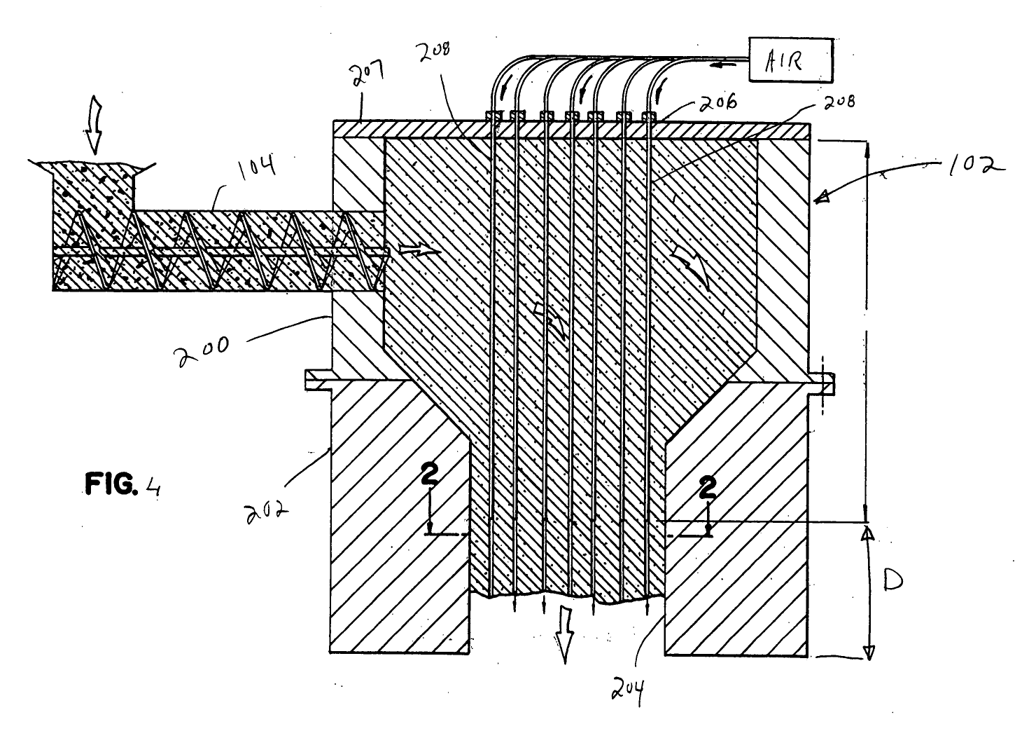

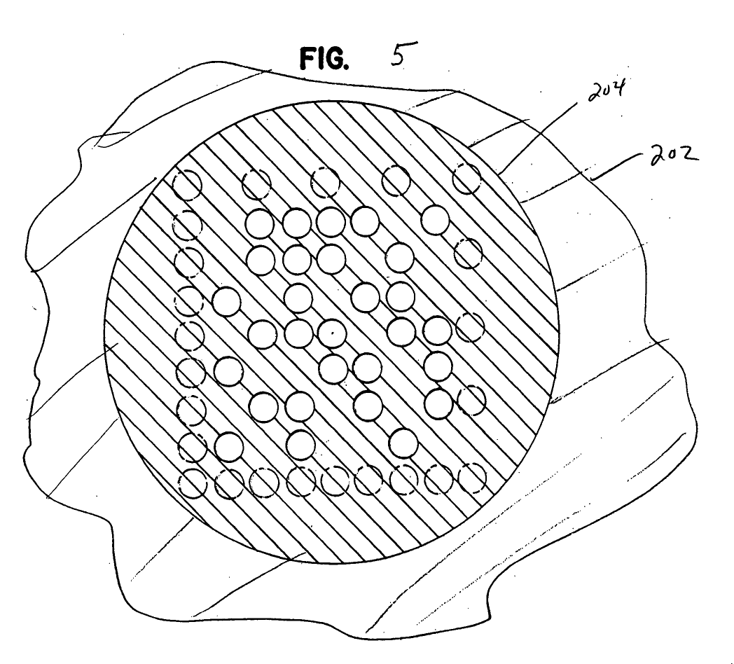

Referring to FIG. 4, an example cross head 102 for vertically extruding a precursor identifier marker structure is shown. The cross head 102 includes a main body 200 that receives viscous thermoplastic material from the extruder 104. A die member 202 mounts to the lower end of the main body 200. The die member 202 includes an interior shape 204 that corresponds to the desired outer shape of the precursor marker structure extruded from the cross head 102. The cross head 102 also includes a tip arrangement 206 that mounts to a top end of the main body 200. The tip arrangement 206 includes a mounting plate 207 secured to the top side of the main body 200, and a plurality of tip member 208 that extend downwardly through the interior of the main body 200 and into the die member 202. Preferably, lower ends of the tip members 208 are vertically offset a distance D from the lower end of the die member 202. The tip members 208 are sized, positioned and numbered so as to correspond to the pattern of openings desired to be provided in each of the identifier markers.

It will be appreciated that the crosshead 102 can be used to manufacture markers having different hole patterns and different exterior shapes. To accommodate this, the cross head 102 can be used with a plurality of different dies and a plurality of different tip configurations. For example, the die 202 is configured to provide a generally circular outer shape to the precursor marker structure. If it is desired to have a marker with a tabbed outer shape, the die member 202 could be replaced with a die member 202′ having an inner surface that includes a tabbed configuration. Other die shapes can also be used.

Similarly, the tip mounting configuration 206 can be replaced with other tip mounting configurations having different numbers of tips, different sizes of tips, and tips with different cross sectional shapes, and tips positioned in different locations. In certain embodiments, the tip mounting plate may have a plurality of openings into which tips can be inserted to provide a desired hole pattern. When the holes are not occupied by tips, the holes can be plugged. In certain embodiments, the tip mounting plate 207 can include a matrix of openings (e.g., a 10 by 10 matrix). By mounting tips in certain openings of the matrix and plugging the other openings of the matrix, different hole patterns can be generated. Some example tip mounting plate embodiments can accommodate at least 50 tips, or at least 100 tips. The pins may be temporarily clamped, screwed, fastened, or otherwise secured to the tip mounting plate.

It is preferred for the tip member 208 to be hollow so as to define an air passage that extends from the top to the bottom of the tips. During extrusion, air can be pumped through the air passages of the tips and into the channels formed in the precursor identifier marker structure. In this way, the air within the channels of the precursor identifier marker structures assist in preventing the extruded channels from closing after the extruded material flows below the tips. In a preferred embodiment, air is provided through the tips on a mass-flow basis dependent upon the rate of extrusion. Example tips may have outer diameters ranging from 0.025-0.075 inches.

It is preferred for the air flow rate of each of the tips to be individually controlled. For example, separate air mass flow controller can be provided for each tip. In certain embodiments, tips closer to the central longitudinal access of the product being extruded from the cross head 102 may require higher air flow rates as compared to tips that are farther offset from the center longitudinal access of the product being extruded through the cross head 102. The separate mass flow rate controllers allows the air flow rate to be customized to optimize performance.

1. A method of manufacturing a consumable product marker for use in the food or pharmaceutical industry, the product marker being configured to be consumed along with products into which the product marker has been incorporated, the product marker comprising at least one identification opening extending through the product marker, the method comprising the steps of:
extruding an elongate precursor marker structure defining a cross-width;
cooling the extruded precursor marker structure to set an extruded shape of the precursor marker structure; and
dividing the precursor marker structure to form the product marker.

2. A method according to claim 1, wherein the manufactured product marker defines a maximum distance across a face of the product marker of about 0.5 micrometers to about 5 millimeters.

3. A method according to claim 2, wherein the manufactured product marker defines a maximum distance across the face of the product marker of about 10 micrometers to about 250 micrometers.

4. A method according to claim 2, wherein the manufactured product marker defines a maximum distance across the face of the product marker of less than about 500 micrometers.

5. A method according to claim 1, wherein the precursor marker structure is divided to form a plurality of product markers.

6. A method according to claim 1, wherein the precursor marker structure is divided along a plane generally perpendicular to a longitudinal axis of the precursor marker structure.

7. A method according to claim 1, wherein the precursor marker structure is divided such that the product marker defines a maximum thickness of about 0.05 micrometers to about 100 micrometers extending between a front face of the product marker to a back face of the marker.

8. A method according to claim 1, wherein the extrusion process includes a step of reducing the cross-width of the precursor marker structure using a draw-down process after initial extrusion of the precursor marker structure.

9. A method according to claim 8, wherein the initially extruded precursor marker structure includes a cross-width of about 1 cm to about 5 cm before the draw-down process.

10. A method according to claim 8, wherein the draw-down process reduces the initial cross-width of the extruded precursor marker structure by about 5 times to about 25 times.

11. A method according to claim 8, wherein after the draw-down process, the cross-width of the precursor marker structure is further reduced by a second draw-down process using a draw tower, wherein in the second draw-down process, the precursor marker structure is re-heated and further elongated.

12. A method according to claim 11, wherein the second draw-down process using the draw tower reduces the previous cross-width by about 100 to about 1000 times.

13. A method according to claim 1, wherein the precursor marker structure is extruded using a polymer.

14. A method according to claim 1, wherein the at least one opening of the product marker initially starts to form during the extrusion step of the precursor marker structure.

15. A method according to claim 1, wherein the extrusion process includes extruding the precursor marker structure around at least one tip member that corresponds to the location of the at least one opening to be formed on the product marker.

16. A method according to claim 1, wherein the formed product marker includes a plurality of identification openings extending through the product marker, the openings formed using a plurality of tip members around which the precursor marker structure is extruded, the tip members being arranged to correspond to the pattern of the identification openings.

17. A method according to claim 16, wherein different hole patterns on the product marker are generated by plugging different tip member openings that correspond to desired hole patterns during the extrusion process.
